(19) United States
(12) Patent Application Publication
(10) Pub. No.: US 2003/0016716 A1
(43) Pub. Date: Jan. 23, 2003

(54) Sonolaser

(76) Inventor: Pritiraj Mahonty, Pasadena, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/835,032

(22) Filed: Apr. 12, 2001

Related U.S. Application Data
(60) Provisional application No. 60/196,662, filed on Apr. 12, 2000.

(51) Int. Cl. H01S 3/22; H01S 3/223; H01S 3/09

(52) U.S. Cl. 372/55; 372/69

(57) ABSTRACT

A novel microcavity sono-gas-laser is provided. The sonolaser comprises a gas molecule suspended within a cavity. In the sonolaser of the application, population inversion is achieved by moving the walls of the laser cavity very rapidly, thereby compressing the cavity to submicron sizes, resulting in lasing from the gas molecules according to the principle of superradiance. Embodiments directed to microcavity lasers, micro-mechanical sonolasers and bubble sonolasers and methods of using the same are also provided along with potential systems for utilizing the sonolaser of the current invention.

### CROSS-REFERENCE TO RELATED APPLICATION

This application is based on U.S. application No. 60/196,662, filed Apr. 12, 2000, the disclosure of which is incorporated by reference.

### FIELD OF THE INVENTION

This invention is generally directed to a sonolaser, or a microcavity laser in which the required population inversion is created by hydrodynamic or sound-wave pumping.

### BACKGROUND OF THE INVENTION

A sonolaser is essentially a microcavity laser, which uses the principle of superradiance. As a comparison, most conventional gas lasers use large cavities. The advantage of using cavities with size comparable to the wavelength of the emitted light is the enhancement of intensity due to interference effects of superradiance. Such microcavities can be realized in many different forms. Examples include micromechanical cavities made from gallium arsenide or silicon based micromachined membrane cavities. In contrast to these mechanical constructs, in a sonolaser, the microcavity is realized by suspending air or gas bubbles in water or other aqueous and nonaqueous solutions. Such bubbles have been extensively studied in the context of sonoluminescence.

For example, incoherent light emission from multiple suspended bubbles was known as early as 1934 when Frenzel and Schultes discovered the emission of light from multiple bubbles trapped in water. Frenzel, H. & Schultes, H. “Lumineszenz im ultraschalbeschickten wasser”; Z. Phys. Chem. 27B, 421-424 (1934). Subsequently, Chambers observed the emission of light in organic liquids. The phenomenon of multiple bubble sonoluminescence (MBSL) in various aqueous solutions has been explored extensively since then. The emission of light has been attributed to a host of mechanisms, the prominent ones being compressional heating from adiabatic collapse of cavity walls, and rapid focusing of energy at the center of the bubble by spherically symmetric shock waves. These theories consisted of a combination of microscopic mechanisms such as blackbody radiation, bremmstrahlung, and various recombination radiation processes depending on the chemical kinetics of the partially ionized gas. See, for example, Barber, B. P., Hiller, R. A., Lofstedt, R, Putterman, S. J. & Weninger, K. R. “Defining the unknowns of sonoluminescence”, Phys. Rep. 281, 65-143 (1997); B., Gunther, R., Nick, G., Pecha, R. & Eisenmenger, W. “Resolving sonoluminescence pulse width with time-correlated single photon counting”, Phys. Rev. Lett. 79, 1405-1408 (1997); Moran, M. J. & Sweider, D. “Measurement of sonoluminescence temporal pulse shape”, Phys. Rev. Lett. 80, 4987-4990 (1998); Pecha, R., Gompf, B., Nick, G., Wang, Z. Q., & Eisenmenger W. “Resolving the sonoluminescence pulse shape with a streak camera”, Phys. Rev. Lett. 81, 717-720 (1998); Hiller, R. A., Putterman, S. J. & Weninger, K. R. “Time-resolved spectra of sonoluminescence”, Phys. Rev. Lett. 80, 1090-1093 (1998); Vazquez, G. E. & Putterman S. J. “Temperature and pressure dependence of sonoluminescence”, Phys. Rev. Lett. 85, 3037-3040 (2000); and Young, J. B., Schmeidel, T. & Kang, W. “Sonoluminescence in high magnetic fields”, Phys. Rev. Lett. 77, 4816-4819 (1996).

However, it was not until the discovery of sonoluminescence from single bubbles that the nontriviality of the effect was appreciated. Sonoluminescence in single bubbles trapped by ultrasound was discovered by Gaitan and coworkers. Gaitan, F. and Crum, L. 1990: “Sonoluminescence from Single Bubbles”, J. Acoust. Soc. Am. Suppl. 1, 87, S141/Gaitan, F. 1990: Ph.D. Thesis, National Center for Physical Acoustics, University of Mississippi. Subsequent work following the pioneering work by Gaitan and coworkers found various puzzling characteristics of single bubble sonoluminescence (SBSL). The most notable feature of the emitted light was the short temporal pulse width on the order of 50 ps or less. It appeared that the characteristics of MBSL and SBSL were distinctly different in that MBSL originated from cooler bubbles (at a nominal temperature of 5000 K.) and SBSL originated from bubbles at extremely hot temperatures. Estimates on the interior temperatures of single sonoluminescing bubbles were as high as a fraction of a million degrees. SBSL was substantially more intense than the MBSL. In MBSL the spectra obtained from various aqueous solutions with different solutes showed distinct atomic and molecular lines, whereas the SBSL spectrum was invariably found to be a featureless continuum. Various other experiments and estimates of extremely high temperatures inside the bubble led to the popular notion that SBSL could be due to an exotic effect seen perhaps for the first time. The ideas were validated on the basis that the conditions inside the bubbles are unusual: extremely high temperatures and pressures in a sub-micron length scale generated during the violent collapse with a turn-around time of a few microseconds. See, for example, Didenko, Y. T., McNamara III, W. B. & Suslick, K. S. “Molecular emission from single-bubble sonoluminescence”, Nature 407, 877-879 (2000); Hilgenfeldt, S., Grossman, S. & Lohse, D. “A simple explanation of light emission in sonoluminescence”, Nature 398, 402-404 (1999); Hilgenfeldt, S., Grossman, S. & Lohse, D. “Sonoluminescence light emission”, Phys. Fluids 11, 1318-1330 (1999); and Moss, W., Clarke, D. & Young, D. “Calculated pulse widths and spectra of a single sonoluminescing bubble”, Science 276, 1398-1401 (1997).

In addition, to the scientific interest in sonoluminescence in general, SBSL has shown great promise as a practical light source because the light generated is capable of emission with a picosecond pulse width, a kilohertz and megahertz repetition rate, and a tunable broadband spectrum. For example, U.S. Pat. No. 5,659,173 discloses the transformation of acoustic energy to other energy forms by suspending and compressing a single gaseous bubble in an acoustic wave, and in one embodiment the authors demonstrated single-bubble sonoluminescence pulses of light having wavelengths on the order of 700 to 200 nm, a pulse length as short as 100 picoseconds, a cycle rate of 50 picoseconds and a power output of ˜100 mW. However, to generate the light pulses disclosed in the '173 patent, the temperature of the single bubble emitter has to be increase to a temperature greater than 10,000 K., and prefer ably as high as ˜100,000 K., where the emitted light is dominated by broadband blackbody emission.

Indeed, despite the considerable research into single-bubble and multiple bubble sonoluminescence, and the considerable promise shown by these phenomena as a potentially commercially valuable light source, no coherent microcavity sonoluminescent light source has been developed. Accordingly there is a need for a sonoluminescent source for tunable coherent superradiance lasing.

### SUMMARY OF THE INVENTION

In the present invention a laser is provided which utilizes hydrodynamic or sound-wave pumping to create the population inversion in the lasing mechanism. The sonolaser generally comprises a microcavity or microbubble, a gas with the metastable states required for lasing and a mechanism for moving the cavity or bubble walls very rapidly.

In one embodiment, the sonolaser comprises a cavity which contains the gas required to set up an active medium or population inversion. During operation the population inversion is created by the rapid compression of the cavity walls surrounding the gas. The compression of the cavity walls results in a rapid increase in the temperature of the gas enclosed therein from its ambient value by two to three orders of magnitude; the enhancement factor depends on the ratio of the net volume change, governed by the ideal gas law of adiabatic expansion. Compression of the cavity to a net volume of a thousand times its original equilibrium size can, for example, result in a final temperature of 50,000 Kelvin (K) or higher. Heating of the gas to such high temperatures results in its ionization. Since the life times of these ionization levels are rather short, the molecules cascade downwards, finally getting stuck in the metastable states with typical life times on the order of milliseconds and seconds. In this compressed state, the gas molecules are within a distance of a micron, comparable to their correlation length. The common electromagnetic field allows the molecules to emit collectively within the correlation length. The collective decay or superradiance of N molecules results in an intensity N² times larger than the emission from an individual molecule in a time scale 1/N times the lifetime of the energy level. Superradiance hence results in an intense and short pulse of light because of the collective radiance effect. Because of the high pressures within the cavity, some of the molecules form excimers, or bound states of excited molecules. Therefore the lasing process in a sonolaser is due to the collective interference effect of the standard lasing from individual excimer molecules.

Any gas having the suitable metastable states can be utilized, such as, for example, a noble gas. Heating of the gas to a temperature of 5,000 K or higher results in the excitation of the gas molecules to higher optical levels, though the percentage of excitation is rather small (this is because the ionization potential of noble gases is high). In an alternative embodiment, the ionization of the gas can be further enhanced by associative ionization processes induced by the presence of a small amount of a heavier rare gas with the appropriate chemistry. Addition of a small percentage of a heavier rare gas allows penning ionization or associative ionization through which all the gas molecules rapidly ionize.

In one embodiment of the invention the lasing cavity is created by a gaseous bubble located within a liquid in a container. In this embodiment the bubble can be located in the liquid via any suitable means, such as, for example, under the action of acoustic energy applied to the liquid. In such an embodiment the compressing and decompressing force is applied to the bubble under the action of a resonating pressure applied to the liquid by any suitable hydrodynamic energy, such as acoustic energy. Varying the resonating pressure will also vary the wavelength of the light energy obtained from the hydrodynamic energy input.

The bubble can be formed via any suitable means. In one embodiment of the invention the liquid is sealed in the container prior to the formation of a gaseous bubble in the liquid, the liquid is preferably degassed and the container is sealed against the ingress or egress of fluid, namely liquid and/or gas, and the liquid is heated to form a cavity or gaseous bubble in the liquid.

In another embodiment of the invention the walls of the microbubble or microcavity are compressed via an acoustic energy wave generated by a piezoelectric device.

In yet another alternative embodiment of the invention the ambient radius of the bubble after emitting light energy is less than about 2.0 microns, and preferably less than 1.5 microns on average. Prior to emitting light the maximum radius is greater than about 3 microns, and more preferably about 5 microns.

In still another embodiment of the invention a machined microcavity is utilized to contain the gaseous bubble. In such an embodiment any suitable microcavity design can be utilized such that the gaseous bubble is sufficiently located and can be compressed via a hydrodynamic wave.

In still yet another embodiment of the invention the temperature of the compressed gas bubble is held below 10,000 K. In such an embodiment it is preferable to have a system in which the temperature of the compressed gas bubble is tunable such that the emission spectrum of the sonolaser can be tuned.

In still yet another embodiment, the invention is directed to a method of manufacturing a sonolaser as described above.

In still yet another embodiment, the invention is directed to a device for utilizing the sonolaser as described above.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic view of a sonolaser according to the present invention.

FIG. 2 is a schematic depiction of the lasing energy levels of a sonolaser according to the present invention.

FIG. 3 is a schematic view of a sonolaser according to the present invention.

FIG. 4 is a graphical representation of the lasing properties of a sonolaser system according to the present invention.

FIG. 5 is a graphical representation of the lasing properties of a sonolaser system according to the present invention.

FIG. 6 is a graphical representation of the lasing properties of a sonolaser system according to the present invention.

FIG. 7 is a graphical representation of the lasing properties of a sonolaser system according to the present invention.

FIG. 8 is a graphical representation of the lasing properties of a sonolaser system according to the present invention.

FIG. 9a is a graphical representation of the lasing properties of a sonolaser system according to the present invention.

FIG. 9b is a graphical representation of the lasing properties of a sonolaser system according to the present invention.

FIG. 10 is a graphical representation of the lasing properties of a sonolaser system according to the present invention.

### DETAILED DESCRIPTION OF THE INVENTION

A sonoluminescence device capable of emitting a coherent beaming of superradiant lasing radiation is described herein. The sonoluminescence device according to the invention being henceforth referred to as a sonolaser.

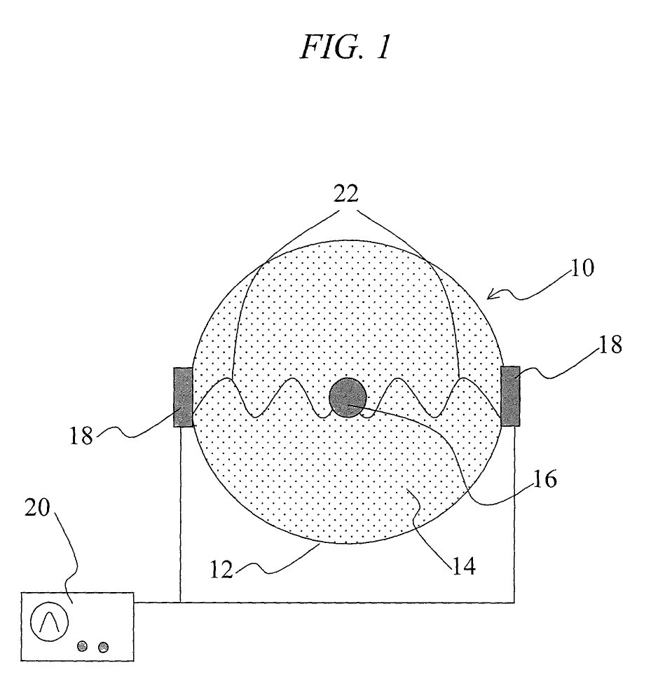

The sonolaser 10 according to one embodiment of the invention is shown schematically in FIG. 1 and comprises a cavity 12 containing a liquid 14 having at least one gas bubble 16 trapped therein. An electrostatic or electromagnetic wave emitter 18 in signal communication with an electrostatic or electromagnetic wave generator 20 is attached to the cavity 12 such that electrostatic or electromagnetic waves 22 generated thereby impinge on the at least one gas bubble 16.

During operation a population inversion is created by the rapid compression of the at least one gas bubble 16. The compression of the at least one gas bubble 16 results in a rapid increase in the temperature of the gas 16 from its ambient value by two to three orders of magnitude; the enhancement factor depends on the ratio of the net volume change, governed by the ideal gas law of adiabatic expansion. Compression of the at least one gas bubble 16 to a net volume of a thousand times its original equilibrium size results in a final temperature of 50,000 K or higher. Heating of the gas 16 to such high temperatures results in its ionization.

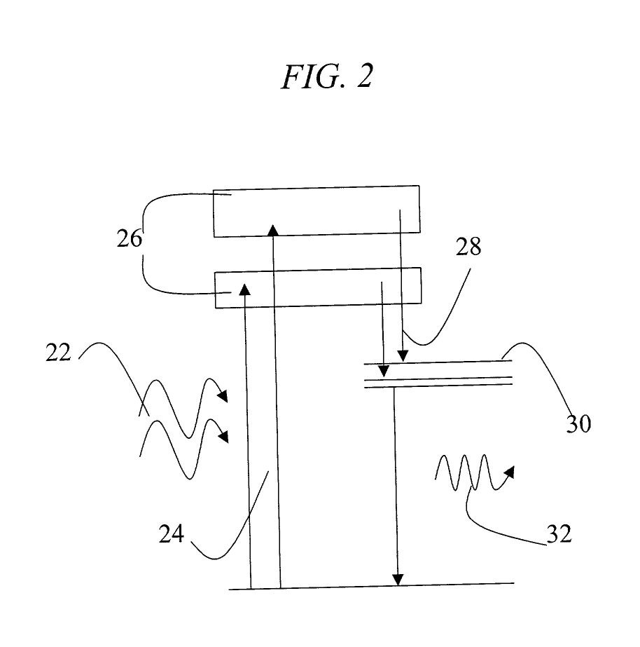

A schematic of the ionization levels of a typical sonolaser 10 system according to the invention is shown in FIG. 2. When the electrostatic or electromagnetic wave 22 impinges on the at least one gas bubble 16, it acts as a hydrodynamic excitation 24 and ionizes the molecules of gas comprising the at least one gas bubble 16 to an excited state 26. Since the life times of these excited state ionization levels 26 are rather short, the molecules cascade downwards 28 nonradiatively, finally getting stuck in the metastable states 30 with typical life times on the order of milliseconds and seconds. In the compressed state, the gas molecules 16 are within a distance of a micron, comparable to their correlation length. This length is typically on the order of the visible wavelength at a few thousand Kelvin. Quantum mechanics prevents the excited molecules 16 contained within the correlation length from radiating independently. Additional quantum-mechanical interference corrections can—and are found to— dominate the incoherent radiation generated merely by heating.

Coherent sonoluminescence is the radiation 32 emitted during the collective decay 32 of the excited molecular states 30, essentially a quantum mechanical process called superradiance. Collective decay 32 from N_{f} phase-coherent molecules results in an enhancement of intensity by a factor of N_{f}². In contrast, incoherent radiation from N molecules is only N times the radiation from a single molecule. Therefore, incoherent radiation becomes negligible compared to coherent radiation 32 if the number of phase-coherent molecules N_{f} is large. Furthermore, lifetime of emission is reduced by a factor N_{f} from the natural spontaneous lifetime T₁ to T₁/N_{f}. This provides a natural explanation for the short pulse width of the emission generated by the sonolaser 10 of the current invention. In contrast, in the incoherent heating model, the short pulse width is attributed to the width of the temperature pulse itself.

The mechanism of superradiance as shown schematically in FIG. 2 is based on the conditions that an inverted medium of atomic/molecular excited states 30 exists for a sufficiently long time, and that the individual radiating entities, the excited atoms and molecules 16, are physically within the correlation length. In a sonolaser 10 according to the current invention, both of these conditions are satisfied. Because of high density during the final stage of compression of the at least one bubble 16, a large fraction of phase-coherent molecules (N_{f}˜10⁴-10⁶) superradiate 32 on a time scale of picoseconds with an intensity larger than the incoherent radiation intensity by a factor of N_{f}. This single-pass gain in a correlated active medium is a mechanism of lasing, different from the conventional multi-pass feedback achieved with mirrors. Some conventional X-ray lasers also use this mechanism for gain because of the lack of a good reflective surface. The common electromagnetic field allows the molecules 16 to emit 32 collectively within the correlation length. The collective decay or superradiance 32 of the N molecules comprising the gas bubble 16 results in an intensity N² times larger than the emission from an individual molecule in a time scale 1/N times the lifetime of the energy level 30. Superradiance hence results in an intense and short pulse of light 32 because of the collective effect. Because of high pressures within the bubble 16, some of the molecules form excimers, or bound states of excited molecules. Therefore the lasing process in a sonolaser 10 according to the invention is due to the collective interference effect of the standard lasing from individual excimer molecules.

Because the light emission from the sonolaser 10 is produce via collective molecular emission 32, the shape of the pulse is different in different regimes of dephasing which occurs due to the loss of phase memory of the collective molecular dipole. If dephasing is weak or absent, then the emitted light is mostly coherent (lasing). In the ideal case of superradiance, then, the dephasing rate is smaller than the superradiance rate 1/T_{R}; where T_{R}=T₁/N_{φ} is the cooperative time. T₁ is the natural life time of the excited molecular level. N_{φ} is the number of phase coherent molecules. Pulse shape is defined by the time dependence of intensity:

$$I ( t ) = I ( 0 ) sec {h}^{2} ( \frac{t - {T}_{D}}{{T}_{R}} ) \qquad ( 1 )$$

where T_{D} is the rise time.

In the regime of strong dephasing, a complete expression for the radiated intensity can be found by the equation:

$$I ( t ) = I ( 0 ) {ⅇ}^{- t / {τ}_{i}} + {τ}_{i} \frac{{ℏω}_{0}}{{T}_{R} {T}_{2}^{eff}} [ g ( {ω}_{0} , {Δω}_{eff} ) + \frac{1}{{ⅇ}^{{ℏω}_{0} / {k}_{B} T} - 1} ] ( 1 - {ⅇ}^{- t / {τ}_{i}} ) \qquad ( 2 )$$

where τᵢ is the dephasing time, ω₀ is the central angular frequency in the band of excited molecular levels, T₂^{eff} is the effective inhomogeneous broadening time, and g(ω₀,Δω_{eff}) is the distribution of excited molecular levels representing population inversion. The next term inside the square bracket gives the thermal blackbody or Planck distribution of the excited levels.

The effective decay rate is then expressed as the dephasing rate:

$$\frac{1}{{τ}_{i}} = \frac{1}{{T}_{2}} ( 1 + 2 κ R ) - \frac{3 {λ}_{0}^{2} {N}_{φ}}{4 {π}^{2} {cRT}_{1}} \qquad ( 3 )$$

where T₂ is the inhomogeneous broadening time, κ is the propagation loss per unit length, R is the propagation length (on the order of the minimum bubble radius Rₘᵢₙ), λ₀ is the central wavelength (roughly 400 nm for the visible range).

In the absence of propagation loss (κ˜0) and negligible superradiance rate 1/T_{R}, the fall time of the pulse is dominated by dephasing due to inhomogeneous broadening:

$$\frac{1}{{τ}_{i}} = \frac{1}{{T}_{2}} \qquad ( 4 )$$

Thus, decay of the pulse is approximately exponential with a time scale of T₂=I(t)˜I(0)e^{-t/T}^{₂}.

Likewise, the size of the light-emitting region is defined by the correlation length of the electromagnetic field R_{φ} at a particular temperature. If it is smaller than the fully-compressed size of the bubble Rₘᵢₙ, then the propagation of the light emitted by the central phase-coherent region will result in the stimulated emission from the molecules outside this region. Propagation-induced stimulated emission will lag behind the central burst, peaking at a later time. This gives rise to ringing or oscillations in the pulse, peculiar to superradiance. In contrast, the correlation length for a blackbody-driven field is comparable to the wavelength, hence ringing in sonoluminescence is expected for short wavelength-i.e., for λ<<Rφ<Rₘᵢₙ.

The pulse shape of the emission 32 contains two distinct parts, the rise time and the fall time. In superradiant laser sonoluminescence, these time scales evolve independently. The rise time T_{D} depends on the cooperative time T_{R}. Its dependence on wavelength and temperature varies in the high and low temperature limits. If the electron temperature in the gas is much higher than the photon energy T>>hc/k_{B}λ, then the rise time depends primarily on T_{R}. Its dependence on wavelength and temperature is logarithmically weak in agreement with the available experimental data. In the low temperature regime, where T<<hc/k_{B}λ, rise time increase with decreasing wavelength and temperature quadratically.

In the dephasing regime, where T₂<<T_{R}, the shape of the pulse is characterized by exponential decay with the characteristic time of T₂. Doppler broadening is most relevant at typical temperatures of ˜20,000K and above. In the superradiant regime, where T₂>>T_{R}, fall time is given by the time scale of superradiance. It is primarily determined by the number of correlated molecules Nφ and their spontaneous lifetimes. There is a secondary, rather weak, dependence on wavelength and temperature through excitation. In the high temperature thermal limit T>>hc/k_{B}λ, the excitation field is blackbody distributed. Whereas in the low temperature regime, T<<hc/k_{B}λ, population of discrete molecular lines dominate thermal population.

The energy emitted in sonoluminescence also contains two parts: that coherent part (lasing) and the incoherent part. As discussed elsewhere, the competition between the two parts is determined by N_{φ} (the number of correlated molecules within the correlation length) and N (the number of total molecules inside the bubble 16 within Rₘᵢₙ). N is fixed, and N_{φ} can be made smaller by increasing the temperature. The amount of energy obtained by coherent emission is given by the fraction of the time during which sonoluminescence is coherent T₂/T_{R}. Only a fraction of the energy is emitted coherently, only for a time T₂ shorter than T_{R}. The rest of the energy is emitted incoherently. Thus, in the dephasing regime the emitted intensity first linearly increases with increasing pulse width, saturating at a value T_{R} (in coherent regime) beyond which T₂ becomes irrelevant. Thus, in the coherent regime, where T₂>>T_{R} the radiated energy is found to be:

E_{coherent}=N [symbol] ω (5)

whereas in the incoherent regime light emission is governed by the heating of the molecules or their interactions with free electrons, and their incoherent decay by various mechanisms. The coherent emission in this region is negligibly small.

Thus, it has been found that the distribution of excited molecular states 26 in the many-body phase-coherent state is dominated by the blackbody excitation field at high temperatures, k_{B}T >> [symbol] w. However, at temperatures below 10,000 K, the distribution contains discrete rotational and vibrational molecular states in the visible range (200 nm-800 nm). The spectral distribution of the many-body excited state is reflected in the emission spectrum of the sonolaser 10. Structures containing molecular lines—though broadened—are expected at shorter wavelengths, or equivalently, at lower temperature. As temperature is further reduced, the longer wavelength regime of the spectrum becomes progressively accessible to the molecular line emission. Therefore, by holding and varying the operating temperature of the sonolaser 10 below 10,000 K. a tunable wavelength coherent light emission 32 can be generated.

Although any gas with suitable metastable states can be utilized in the current invention, in hotter bubbles 16 of argon and other noble gases with higher atomic number (smaller ionization potential), electronically bound molecular states or excimers are formed, though the interaction between the constituent atoms is mostly repulsive. Excimers with strongly repulsive ground states emit broad continuum radiation whereas the weakly bound excimers typically display a radiation spectrum with rotational and vibrational structure. As a result, noble gases (He, Ne, Ar, Xe, and Kr) and other metastable compounds (N, N₂, CO, CH₂, C₆H₆, CN) including alkali and transition metals (Na, Fe, Cr) radicals have metastable states with long lifetimes (ms-ms) and are preferred. Even in this preferred embodiment, the hydrodynamic heating to an interior temperature of 5,000 K.-40,000 K. (˜0.5-4 eV) as a result of compression of the gas bubble 16 by an acoustic wave 22 gives rise to a rather small degree of ionization (<10%). In one embodiment according to the invention, ionization is enhanced by the presence of a small amount (1%) of impurities, typically another noble gas, such as Xenon in an Argon bubble, by Penning or associative ionization. The life time and ionization potentials of some molecules used as sonoluminescencing bubbles 16 according to the invention are presented in Table 1, below.

TABLE 1
Properties of Selected Sonoluminescent Species

| | Ground | Metastable | Energy | Temperature | |
|---|---|---|---|---|---|
| Species | state | state | (eV) | (° K) | Lifetime (sec) |
| H | ²S_{1/2} | 2²S_{1/2} | 10.20 | 118,258 | 0.12 |
| He | ¹S₀ | 2³S₁ | 19.82 | 229,793 | long |
| Li | ²S_{1/2} | ⁴P_{5/2} | 56.0 | 649,264 | 5e−6 |
| N | ⁴S | ²D | 2.38 | 27,593 | 6e4 |
| Ne | ¹S₀ | ³P_{2;0} | 16.62 | 192,692 | long |
| Ar | ¹S₀ | ³P_{2,0} | 11.55 | 133,910 | long |
| H2 | 1Σ⁺_{g} | c³Πᵤ | 11.86 | 137,504 | long |
| N2 | 1Σ⁺_{g} | A³Σ⁺ᵤ | 6.16 | 71,419 | 0.9 |
| CO | 1Σ⁺ | a³Π | 6.01 | 69,680 | long |
| NO | ²Π | a⁴Π | 4.7 | 54,492 | long |
| CH₂ | 3Σ^{Δ}_{g} | a¹A₁ | 1.0 | 11,594 | long |
| C₆H₆ | ¹A_{1g} | A¹B₂ᵤ | 4.9 | 56,810 | 6e−7 |

In one embodiment, an Ar gas bubble 16 is utilized. Heating the Ar gas bubble to a high temperature ˜5,000 to 40,000 K from hydrodynamic collapse causes electronic excitation of the Ar gas atoms, either according to:

e+Ar→Ar*+e⁻

or

e⁻+Ar→Ar⁺+2 e⁻ (7)

with a population of e^{-Eion/kBT} or e^{-Eex/kBT} respectively. Since the ionization energy of Ar is ˜12 eV, this corresponds to a small degree (˜3%) of ionization at a temperature in the range of 0.86 to 3.5 eV. The atomic excitation to Ar* is much more efficient. However, a large amount of initial ionization is not important for the formation of excimer states. Ar excimers formed mostly in many excited states quench to lower states at high pressures and the excitation resides mostly in the lowest excited levels of atomic and molecular levels. The radiative lifetime T₁ of the most relevant excited state Ar₂* (for the 1ᵤ molecular state which dominates over the Oᵤ^{+ state) is known to be} 3×10⁻⁶ s.

As mentioned above the presence of a small amount (˜1%) of a heavier rare gas in a large amount of lighter rare gas results in enhanced ionization. These impurities can dimerize, recombine and react to form various diatomic gas excimers. If the excited species are sufficiently energetic, they react with the heavier rare gas atoms, Xe in Ar for example, to form ions in Penning ionization:

Ar*+Xe→Ar+Xe⁺+e⁻

or in associative ionization:

Ar*+Xe→ArXe⁺+e⁻ (8)

These reactions happen on a fast time-scale and occur at every collision. If Penning or associative ionization is not energetically favored, then the energy of the lighter species transfers to the heavier species by the reactions:

Ar*+Xe→Ar+Xe*

or

Ar*₂+Xe→2Ar+Xe* (9)

As discussed above other rare gas and rare-gas-halogen excimers and quasi-bound metal vapor excimers are capable of showing lasing in the sonoluminescence configuration. The above chemical kinetics analysis applies to all other kinds of excimers, thought the details of the collision mechanisms and reaction rates are different.

The at least one gas bubble 16 can be formed in the liquid 14 by any suitable means, such as, for example, by resistively heating a wire held within the liquid or injecting a bubble into the liquid directly via a syringe. Using a syringe, the at least one bubble 16 is created by jetting a small quantity of liquid through the liquid 14, introducing at least one bubble 16 into the liquid 14 and then forcing these to the center of the cavity 12 by the emitters 18. Utilizing a resistively heated wire the at least one bubble 16 is created by locally boiling the liquid 14 by sending a high current through a small piece of wire, such as, for example, a Nickel-Chromium (NiCr) wire welded to large gauge copper wire, which makes cavities into which air diffuses and these bubbles result in the at least one bubble 16 at the center of the cavity 12. The boiling method described above has the advantage over electrolysis that it will work in nonionic liquids. Another method for creating the at least one bubble 16 is to momentarily increase the emission 22 to produce cavitation (typically 10 to 20 times above the drive necessary for producing sonoluminescence). As with the heater, gas diffuses into the cavities from the liquid 14 to form bubbles which coalesce into the at least one bubble 16 at the center of the cavity 12.

Any suitable number and size of bubble 16 can be utilized such that the electromagnetic or electrostatic force 22 is capable of trapping and compressing the bubble. In a typical embodiment the uncompressed gas bubble 16 is on the order of 5 to 10 μm and collapses to a typical size of 0.5 μm creating a corresponding equilibrium pressure of 1.5 atmosphere and a compressed pressure of 1,000 atmosphere. Typical temperatures in the interior of an Argon gas bubble can be higher than 10,000 K, although it should be noted that emission at a temperature higher than about 20,000 K would be dominated by black-body radiation in the visible range. It should also be noted that the use of multiple bubbles 16 dramatically reduces the internal temperature of the gas to a typical value of about 5,000 K. As noted above, the tuning of the final temperature allows a transition from the continuous blackbody spectrum to discrete spectrum of the emitted light, cooler bubbles also show the most coherence. Thus, in a preferred embodiment, the final temperature of the at least one gas bubble 16 according to the invention is held below 10,000 K.

The emitters 18 used can comprise any electromagnetic or electrostatic source capable of emitting an electromagnetic or electrostatic wave 22 suitable for compression of the at least one gas bubble 16. For example, the emitters may consist of a set of piezoelectric transducers (PZTs) 18 for producing sound waves attached to the cavity 12 containing the liquid 14. The PZTs 18 thus provided produce sound waves 22 used to trap and drive the bubble 16. The emitters 18 can be constructed from any suitable material. For example, a PZT is a crystal or ceramic that produces sound by changing its size when a voltage is introduced across it, such as, for example, hollow cylinders polarized radially and disks polarized longitudinally of lead titanate-zirconate piezo ceramic. Finally, the emitters 18 can be indirectly or directly attached to the cavity 12 via any suitable means, such as for example, epoxying the sound emitting faces of the PZTs 18 to the outside surface of the cavity 12. Any suitable epoxy may used such that the electromagnetic or electrostatic waves 22 from the emitters 18 are adequately transmitted into the cavity 12. For example, a common two-part 5-minute epoxy may be used. Although a conventional acoustic wave emitter 18 is described above, it should be understood that any electromagnetic or electrostatic emitter 18 suitable for trapping and compressing the at least one gas bubble 16 may be utilized, such as, for example, laser-induced and magnetic field focusing cavitation.

A sonolaser 10 can have any number and arrangement of emitters 18 thus attached to the cavity 12 such that sufficient electromagnetic or electrostatic energy is delivered to position and compress the at least one gas bubble 16. In a preferred embodiment a symmetric arrangement of emitters 18 is provided such that the emitted force of the electromagnetic or electrostatic waves 22 are balanced and the thus do not move the at least one gas bubble 16 within the cavity 12. In one embodiment, then, the sonolaser 10 is constructed with two emitters 18, on opposite sides of the cavity 12. When more than one emitter 18 is used on a cavity 12, the polarization vectors and applied electric fields are preferably oriented to get an additive electromagnetic or electrostatic wave amplitude at the center of the cavity 12. It should be noted that the number of excited states in the gas bubble 16 depends on the degree of excitation (ionization) which changes with magnetic field. A strong magnetic field inhibits electron diffusion because the mean free path between two successive collisions are extended by cyclotron orbit. The diffusion of electrons on the plane perpendicular to the applied field direction is reduced and the diffusion constant depends on the electron density in an ideal gas. In the presence of a strong magnetic field, diffusion in the plane perpendicular to the magnetic field is enhanced, contributing to loss. Thus, directionality of the emitted photons 32 is also affected by a strong magnetic field. For example, a light emitting region that is initially spherical can become ellipsoidal because of the diffusive loss in the plane perpendicular to the applied field.

Likewise, although a spherical flask is utilized as a cavity 12 in the embodiment shown in FIG. 1, any cavity 12 having sufficiently high quality factor (Q) radically symmetric modes can be utilized. Thus, cavities 12 of various sizes, materials and properties can be utilized. It should be noted that the shape of the light-emitting region will determine the inherent directionality of the sonoluminescence, the resonant electromagnetic or electrostatic frequency will be the eigenmode of the chosen cavity 12 containing the liquid 14 and the eigen frequency will also determine the repeat frequency of the light pulse as a single pulse emitted per acoustic cycle (frequencies as high as 2 MHz have been observed with the appropriate cell design). Thus, in a spherical cavity 12, for example, radically symmetric modes are important because such modes aid in the production of the large amplitude electromagnetic or electrostatic waves 22 necessary to produce ionization of the at least one gas bubble 16. Likewise, because these modes have a pressure antinode at r=0, they are able to trap the at least one gas bubble 16 at the cavity 12 center. The normal modes of a cavity 12 are found by subjecting solutions of the wave equation to the appropriate boundary conditions. The necessary math and descriptions of the relevant functions can be found in the literature, which is incorporated herein by reference (Arfken, G. 1985: Mathematical Methods for Physicists, Academic Press). Such a cavity 12 can be constructed out of any suitable material such that the cavity 12 has little aberrant effect on the sonoluminescence originating from the gas bubble 16, such as, for example, glass (Pyrex.RTM., Kontes.RTM.) or quartz (G. M. & Assoc. synthetic fused silica).

The cavity can be filled with any suitable liquid 14, such as, for example, water, oil or a liquified gas such as argon, nitrogen or oxygen. In one embodiment, the liquid 14 is water. In a preferred embodiment the water 14 is first degassed to prevent the at least one bubble 16 from growing via rectified diffusion and becoming unstable and too large to remain trapped by the electromagnetic or electrostatic field 22. Any suitable technique for degassing the liquid 14 can be utilized including boiling and stirring the liquid under vacuum as described in Battino, R., Banzhof, M., Bogan, M., and Wilhelm, E. 1972: “Apparatus for Rapid Degassing of Liquids, Part III”, Anal. Chem. 54, 806-807, or applying a large amplitude electromagnetic or electrostatic field to the liquid under vacuum as described in Leonard, R. 1950: “The Attenuation of Sound in Liquids by a Resonator Method,” Technical Report, UCLA; both incorporated herein by reference. In such an embodiment, it should be noted that the emission 32 is also dependent on the liquid 14 temperature Tₐ and on the ambient pressure P_{a.}. In effect, the maximum ambient radius Rₐₘₐₓ/R₀ increase with decreasing bath temperature. This enhanced expansion ratio indicates higher temperatures inside the bubble 16. This increase the excited state population and hence the emission intensity. A similar effect is observed on pulse width by changing the ambient pressure. An increasing R₀ implies a lower gas temperature upon compression. If one assumes that the pulse width is dominated by the dephasing time due to the Doppler broadening, then increasing Pₐ yields lower T, and hence a larger pulse width, and for longer wavelengths the pulse width is longer.

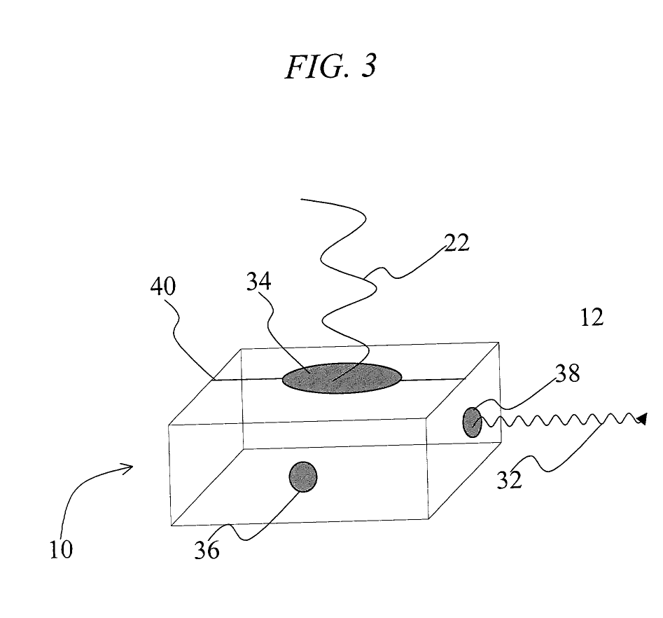

Although a conventional liquid trapped single gas bubble cavity 12 was utilized in the embodiment shown in FIG. 1, it should be understood that any suitable cavity arrangement that provides a method of compressing a suitable gas sample can be utilized to produce the sonolaser of the current invention. FIG. 3 shows an alternative embodiment of the sonolaser 10 utilizing a micromachined microcavity 12 having a deformable membrane 34 disposed between the gas sample and the atmosphere. In this embodiment the cavity 12 is a micromachined microcavity formed such that a cavity body 12 is formed having a deformable membrane 34, a gas inlet 36 for introducing the gas into the cavity body 12 and an optical outlet 38 for emitting the laser emission 32 produced during operation. The pumping of the gas molecules within the cavity 12 is achieved by the compression and expansion of the membrane surface 34 by the application of an electromagnetic or an electrostatic force 22. The electromagnetic of electrostatic force 22 can be induced by any suitable means, such as, for example, an acoustic transducer (not shown) or via an electrical input 40, such as by the application of a voltage (electrostatic) or passing a current in the presence of a magnetic field (magnetomotive). This allows the switching of the laser by a magnetic field. Although any size and shape cavity suitable for a particular application can be utilized, typical sizes of the cavities 12 range from 10 to 100 microns, while the height of a typical cavity 12 is on the order of a micron.

The micromechanical cavities of the current invention can be fabricated by any conventional technique, such as, for example, optical lithography, e-beam lithography and surface micromachining. The cavities can be created for example by the surface micromachining of two wafers and the subsequent wafer bonding by anodization. Any suitable conventional material can be utilized in the construction of such microcavities, including: silicon, silicon nitrite, gallium arsenide, and silicon carbide.

The typical acoustical resonances generated in the sonolaser 10 of the current invention have frequencies from 10 kHz to 10 MHZ and Qs of roughly 1000. This means an electromagnetic or electrostatic generator 20 with precision and stability of a single Hz at these frequencies is necessary to drive the acoustical resonances appropriately. As such, the electromagnetic or electrostatic generator 20 according to the invention can comprise any electronics suitable for controlling the emitters 18 to trap and compress the at least one bubble 16 at a desired level. For example, in an embodiment utilizing sound waves as the emission 22, the generator 20 may include a feedback oscillator used to drive an acoustic resonator to produce sonoluminescence. In such an embodiment, a signal measuring the acoustic oscillations in the resonator is amplified and phase shifted and sent to driving transducer emitters 18. Unlike the oscillator above, the acoustic resonator has many modes so the driving circuit incorporates a band-pass filter to select only the desired acoustic mode. After choice of a proper feedback gain and phase shift, the oscillation exponentially increases to such an amplitude that the at least one bubble 16 is trapped in the cavity 12. Once the at least one bubble 16 has established a steady state, the acoustic amplitude is increased to compress the at least one bubble 16 creating sonoluminescence. In such an embodiment, the amplitude of the sound field with a captured bubble may be adjusted by changing the gain of the feedback. If the gain is set so high that the drive is too large for the bubble to exist, repeated creation of bubbles and driving them to their death occurs thus recovering the classic relaxation oscillation. This system of drive also has the advantage that if the natural frequency of the system changes, the resonance is tracked. Such a feedback system can also be utilized to create the at least one bubble 16 by exceeding the cavitation threshold. In this case, as described above, gas dissolved in the liquid 14 diffuses into the cavities, forming bubbles which coalesce at the pressure antinode to form the at least one bubble 16.

The ability to maintain constant intensity sonoluminescence depends on keeping the emission 22 felt by the at least one bubble 16 as constant as possible. Certain conditions which change in the operating environment such as temperature can change the acoustics and the use of feedback is necessary. The change in the phase of the acoustic oscillation in the resonator, or of the light emitted by the at least one bubble 16 is used to correct the drive frequency so that the response amplitude remains constant. A lock-in amplifier can be used for example to measure the phase difference between its input and a reference which we choose to be the drive. As the resonance frequency shifts, perhaps due to temperature changes, there is an associated phase change between the drive and the response signal. The phase changes monotonically with frequency near resonance so that the voltage produced by the lock-in proportional to this phase can be used to make corrections to the oscillator frequency. Signals used for input to the lock-in show the phase change associated with the natural frequency change. For example, when utilizing an acoustically driven system, inputs may include the voltage from a microphone (not shown) outside but near the cavity 12, the voltage from a PZT emitter 18 cemented to the cavity 12, the current drawn by the PZTs 18 and the signal from a photomultiplier tube (PMT) (not shown) detecting the sonoluminescence.

The invention is also directed to a method of utilizing a sonolaser as described herein. Only as an exemplary method, a description is provided in the following for utilizing the sonolaser 10 as depicted in FIG. 1, it should be understood that other methods and steps might be required to utilize other embodiments of the sonolaser described herein.

In a first step, the liquid 14 provided within the cavity 12 of the sonolaser 10 is degassed as described above to remove any unwanted gas bubbles. Then the resonant frequency of the cavity 12 must be determined such that the emitters 18 are capable of trapping a gas bubble 16 when introduced. Any suitable method of determining the resonant frequency of the cavity 12 can be used. For example, if acoustic wave emitters 18, such as transducers are utilized, a microphone can be used outside the sphere to detect the increase in pressure amplitude at the resonance. Then at least one gas bubble 16 is introduced into the cavity 12. As described above, any suitable means can be utilized to introduce the at least one gas bubble 16, such as drawing a small amount of water into a syringe, withdrawing the needle from the liquid and with the acoustic drive on, squirt some water through the surface. This action will drag some air bubbles 16 into the water. Alternatively, thrusting a probe, a thin metal rod, through the surface will usually drag air bubbles into the water. Any unwanted bubbles can be remove by lowering a probe near them, then after they adhere to the probe, simply remove them.

After introducing the at least one gas bubble 16 into the cavity 12 the electromagnetic or electrostatic emitter 20 is adjusted so as to first stabilize the at least one gas bubble 16 within the liquid 14 of the cavity 12. The emitter strength must be carefully balanced, at low emission level the forces, are so weak that the at least one bubble 16 will not be trapped at the center of the cavity 12 or will be dissolved within the liquid 14, while at higher levels, the at least one bubble 16 could be dissolved or extinguished prior to stabilization. Once the at least one bubble 16 is stabilized in the cavity 12, the emission level of the emitters 18 is increase again to induce sonoluminescence. As the emission is increased above the lower sonoluminescence threshold, the at least one bubble 16 will compress and decompress under the influence of the emission 22 to create a coherent laser emission having a duration on the order of picoseconds (˜10 picosecond) emission with a cycle rate of 10 kHz to 2 MHZ. Thus, the light is emitted during the compression of the cavity in each acoustic cycle.

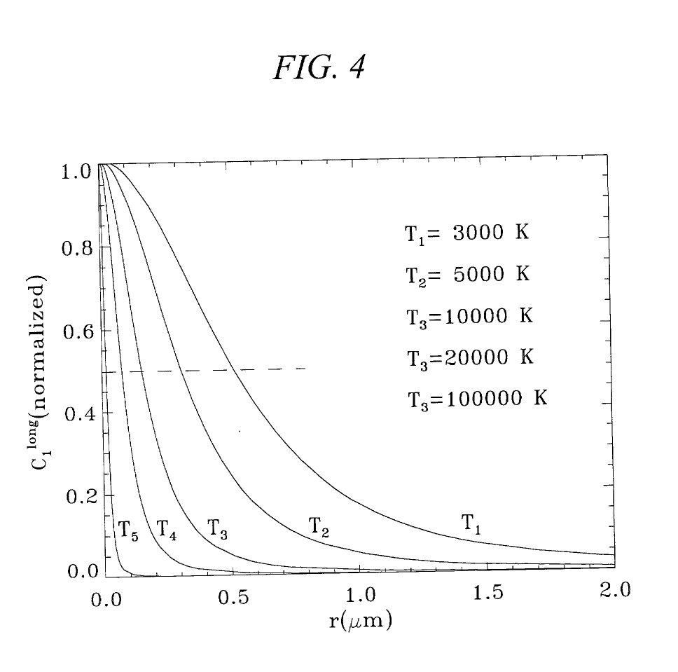

The laser emissions 32 from a sonolaser according to the present invention comprise millions of photons reaching a peak power of ˜400 mW where the emissions 32 come out in a clock-like fashion from 1,000 cycles up to 100,000 per second. The number of photons contained in each emission 32 depends on the strength and nature of the applied field 22 and the temperature of the gas bubble 16. The spectrum, shape of the pulse, and pulse width are all also very sensitive to the gas temperature. FIGS. 4 to 10 demonstrate the properties of the superradiance emissions obtained utilizing a prototype of the invention constructed according to the embodiment shown in FIG. 1.

FIG. 4 demonstrates a comparison of the correlation length of the common electromagnetic field of the compressed molecules contained within the at least one gas bubble 16 of the invention compared with emission wavelength at several bubble temperatures. As shown, the visible wavelength is attainable even at temperatures as low as a few thousand Kelvin. Specifically, FIG. 4 shows the variation of the normalized coherence function at five different temperatures showing the length over which the emitting molecules are correlated. The correlation length is on the order of 0.3 microns at 5,000 K, and 0.02 microns at 100,000 K. At lower temperatures, T<15,000 K, the correlation length is comparable to the minimum bubble size. As a result, at these low operating temperatures, all the emitted intensity is from collective decay of excited molecules.

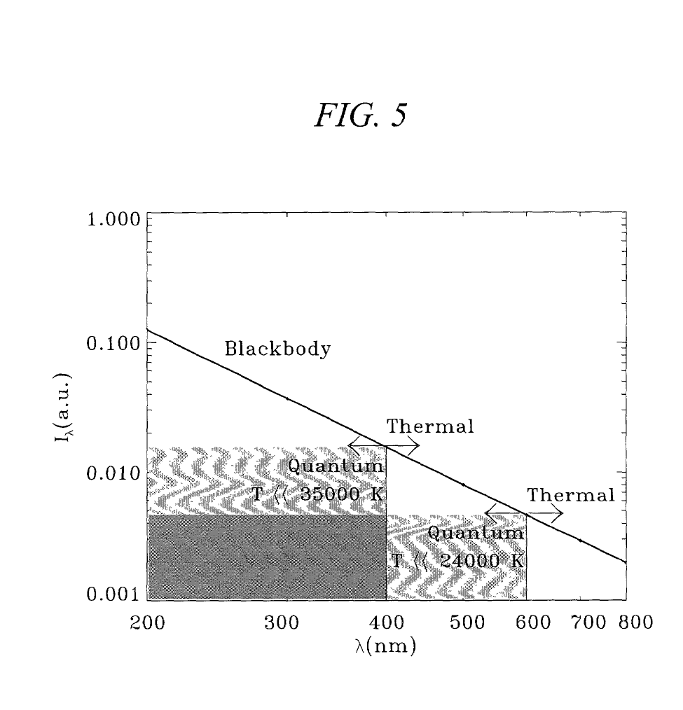

Although FIG. 4 demonstrates that the visible wavelength is obtainable at temperatures as high as 1,000,000 K, FIG. 5 shows that at temperatures above 10,000 K the distribution of the excited molecular states in the many-body phase-coherent state is dominated by the blackbody excitation field at temperatures where k_{B}T >> [symbol] ω. As a result, the quantum and thermal regimes in the emission spectrum depend on the temperature of the excitation spectrum. For example, a bubble with an interior temperature below 35,000 K. will display structures such as spectral lines below 400 nm. Above 400 nm, the emission spectrum will be dominated by thermal spectrum. Thus, the spectrum of the emitted light 32 is blackbody distributed for gas temperatures of 20,000 Kelvin or higher, while below 20,000 Kelvin the spectrum of the emitted light contains discrete molecular and vibrational lines. As a result, for low gas temperatures the spectrum also depends strongly on the gas composition allowing for a tunable sonolaser at these lower temperatures. For example, for the sodium D-lines (˜589 nm) to be observable in single bubble sonoluminescence, the temperature must be a fraction of 24,000 K.

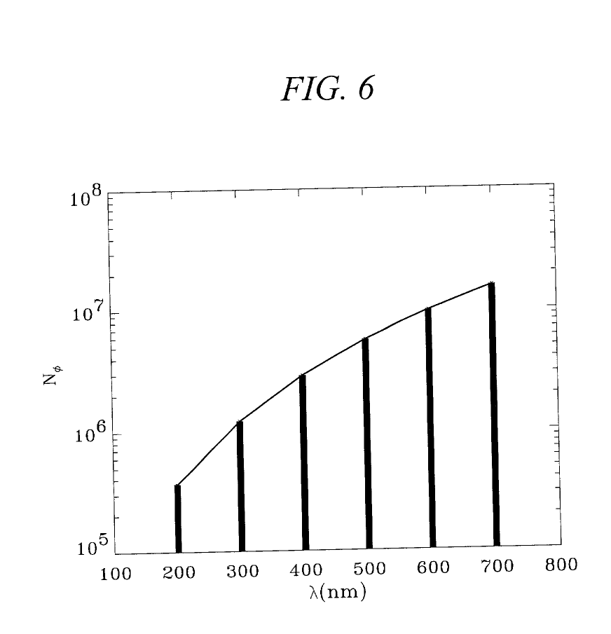

FIG. 6 shows the spectrum distribution of the emitted phase-coherent molecules of the sonolaser 10 of the present invention. At temperatures below 10,000 K, the distribution contains discrete rotational and vibrational molecular states in the range between 200 and 800 nm. The spectral distribution of the many-body excited state is reflected in the emission spectrum. Structures containing molecular lines—though broadened—are expected at shorter wavelengths, or equivalently at lower temperature. Deviation from the blackbody distribution at shorter wavelengths has been observed many times. As the temperature is further reduced, the longer wavelength regime of the spectrum becomes progressively accessible to the molecular line emission. Recent experiments with a temperature below 15,000 K, however, still show emission lines in the short wavelength region of the spectrum. In calculating the data for this figure we assume monochromatic excitation at various wavelengths depicted in the figure. Furthermore, we have assumed that all the molecules inside the bubble are excited to a particular frequency corresponding to each of these wavelengths. In a realistic bubble, a mixed state of excitation occurs, and the number of correlated molecules from individual discrete lines will thus be comparatively smaller than what is depicted in this figure.

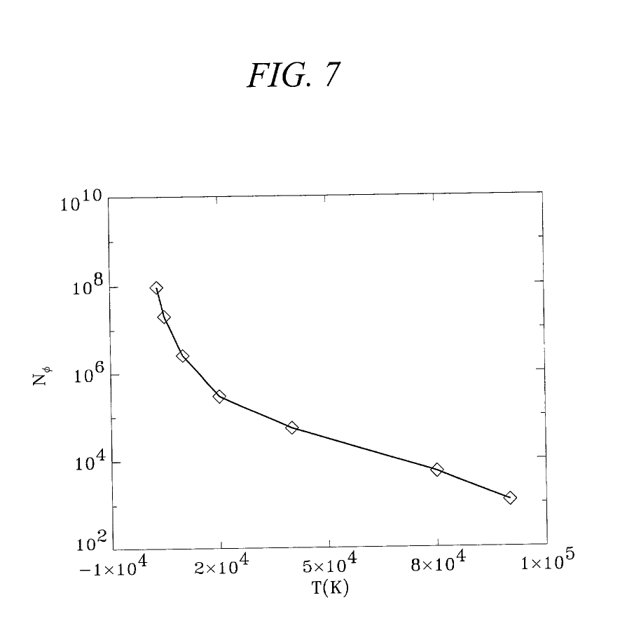

The number of photons and the total intensity also depend on the ambient pressure and temperature of the cavity 12 or the at least one bubble 16. FIG. 7 shows the fraction of phase-coherent molecules (N₊₁₀₀)which superradiate coherently as a function of bubble temperature (T). As shown as the temperature of the bubble is increase the number of phase-coherent superradiating molecules decrease by almost a factor of two and the emission of incoherent radiation concurrently increases.

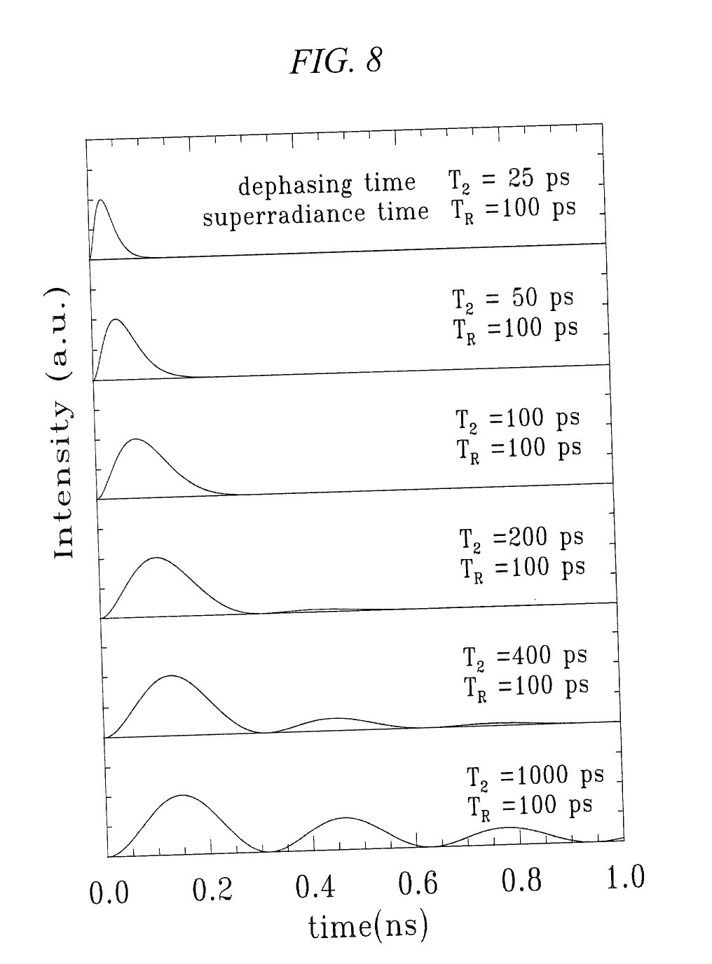

Both the pulse width and the shape of the pulse, ie., the coherence of the pulse, also depend on the temperature of the at least one gas bubble 16 in the compressed state. FIG. 8 shows the results of the dephasing of the many-body phase-coherent state of the sonolaser at high gas bubble temperatures for the pulse shape and width. Increasing dephasing effect is shown in the graph from bottom to top. In a simple model, the light pulse from the sonolaser 10 is emitted from a collective molecular dipole, whose equation of motion is equivalent to that of a damped harmonic oscillator. A pure superradiant pulse is obtained if dephasing (damping) is weak, corresponding to the oscillatory case (under damped). Exponential decay of the pulse is obtained if dephasing (damping) is strong, corresponding to the overdamping case. For comparable scales of dephasing T₂ and collective lasing decay T_{R}, ringing oscillations are observed.

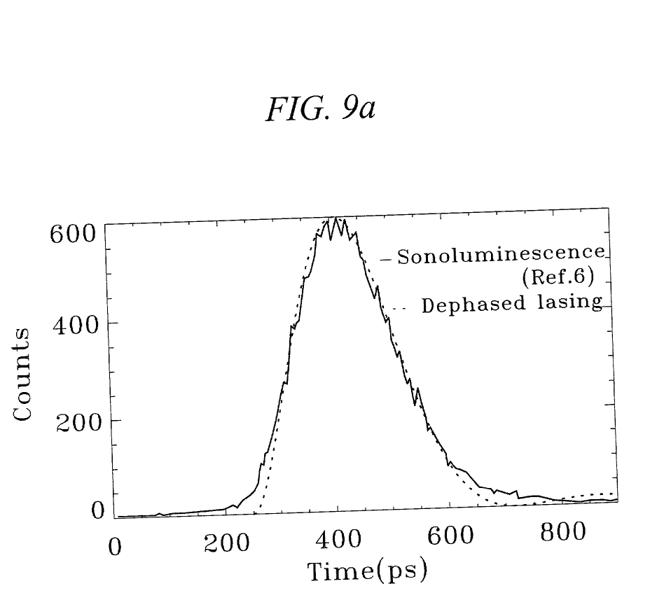

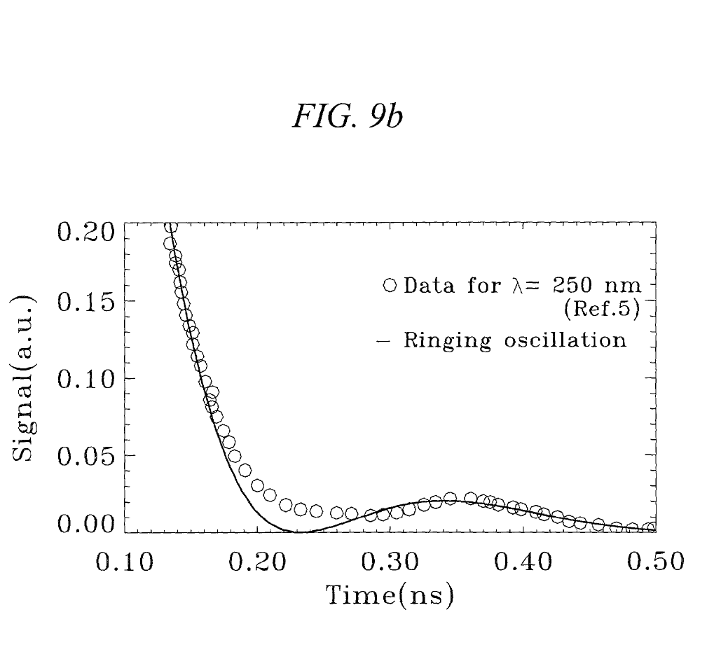

A comparison between a measured sonoluminescence pulse at 250 nm in the underdamped regime and the expected form showing ringing in the simplest model of our theory, containing the two parameters T₂ and T_{R} are shown in FIGS. 9a and 9b. As shown, there is excellent agreement between the observed and calculated spectra.

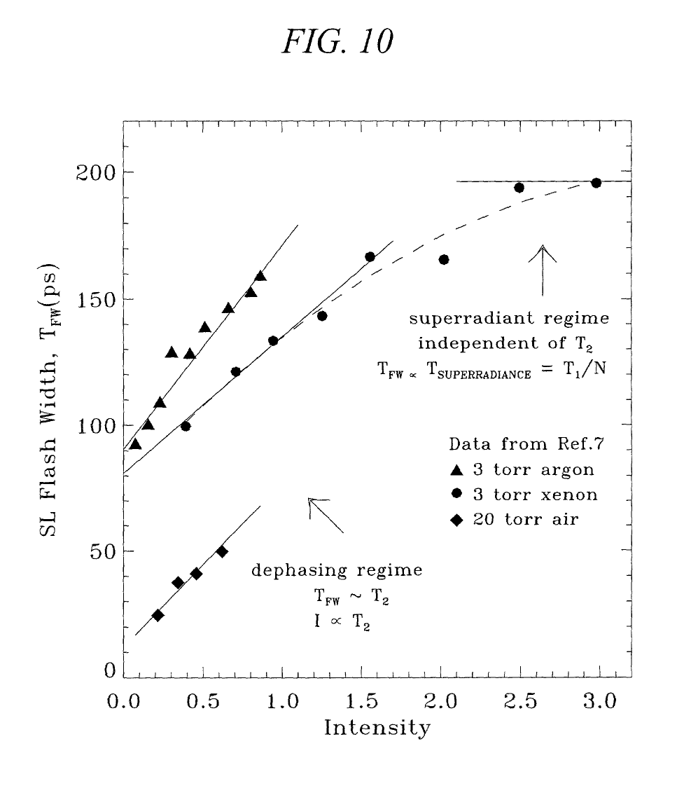

Finally, a comparison to the measured dependence of integrated intensity Iᵢₙₜ on T₂ in experiments is shown in FIG. 10. As shown, as dephasing becomes weaker, or T₂ becomes longer, transition to the ideal superradiance case occurs, where the relevant time scale is the superradiance time T_{R}. Specifically, FIG. 10 shows a comparison between the measured sonoluminescence flash widths for 3 torr Ar, 3 torr Xe and 20 torr air. as shown intensity is linearly proportional to the dephasing time T₂, the fraction of time over which collective lasing occurs. Note that the measured flash width is composed of the fall time (˜T₂) and the almost-constant rise time which contributes to the finite y-intercept. As the dephasing time increases, and becomes larger than the collective lasing time T_{R}, the flash width is solely determined by T_{R}, and is independent of T₂. Thus, as the temperature increase, coherence gets progressively lost by Doppler broadening.

The light emission 32 of the sonolaser 10 of the current invention is typically uniform in all directions, namely directed spherically from a point source under normal conditions, however, the directionality of the light depends on the excitation and the direction of which can be altered by excitation of the light by another directed laser light.

In one embodiment the invention is also directed to a picosecond laser device comprising a sonolaser as described above. The laser system described here is a simple alternative to the conventional picosecond lasers with many other advantages. The repetition rate of the sonolaser is determined by the acoustic frequency, which can range from tens of kilohertz to tens of megahertz. The power output is on the order of 10 milliwatts. The wavelength and coherence of the laser can be tuned over the visible and the ultraviolet range by altering the temperature of the at least one gas bubble 16 and the gas species. The emitted light is omnidirectional.

The present invention is also directed to a micromechanical or membrane or micro-diaphragm based microcavity lasers as described above. In one embodiment, the microcavity laser is integrated on a microchip processor, providing an on-chip gas laser. Alternatively, because of the size and sturdiness of the micromachined microcavity according to the invention, the microcavity sonolaser can be combined with any number of complementary micromechanical optical systems, such as, for example, being integrated with a lab-on-a-chip processes, thus providing an on-chip light source, or for us in bio-fluidics, such as switches and stimulants for various biological processes or for detection and stimulation of various luminescence properties of molecules in biological systems including DNAs.

The microcavity sonolaser can also be used as a picosecond integrated switch for any suitable application, such as, for example to change the electron concentration of a gallium arsenide and two-dimensional electron gas systems. In such an embodiment, the picosecond integrated switch (with gallium arsenide or other materials with high responsivity to light in the optical or ultraviolet range) is operated by changing the electron density effectively at a high repetition rate. Any of the above described systems could include the application of directionally controlled light for applications in biology and optical networks. In such a system an incoming light could be utilized to stimulate radiation in a preferred direction.

The devices described above can be alternatively covered with a filter to allow the passage of only a single wavelength of light with a narrow bandwidth. An array of these filtered cells could then be used to create a tuning device with a visual output, driven by electromagnetic or electrostatic sources at the end of the array. By tuning the source frequency, the position of the nodes and antinodes can be moved which would allow the ability to turn particular cells of the array off. Combining the outputs of multiple cells of such an array could be used to create many colors for example in a color display. Utilizing acoustic waves would allow the creation of a non-electronic visual display system which could operate at a very high frequency, i.e., the frequency of the acoustic wave.

The elements of the apparatus and the general features of the components are shown and described in relatively simplified and generally symbolic manner. Appropriate structural details and parameters for actual operation are available and known to those skilled in the art with respect to the conventional aspects of the process.

Although specific embodiments are disclosed herein, it is expected that persons skilled in the art can and will design alternative sonolasers that are within the scope of the following claims either literally or under the Doctrine of Equivalents.

What is claimed is:

1. A sonolaser comprising:
a cavity defining an inner volume;
a quantity of gas contained within the inner volume;
at least one energy emitter for emitting an energetic wave in radiant communication with the inner volume, wherein the energetic wave is capable of compressing the quantity of gas such that the quantity of gas emits a substantially superradiant coherent visible light emission.

2. A sonolaser as claimed in claim 1 further comprising a liquid contained within the inner volume.

3. A sonolaser as claimed in claim 2, wherein the liquid is selected from the group of: water, oil, liquid nitrogen, and liquid argon.

4. A sonolaser as claimed in claim 2 wherein the quantity of gas is suspended within the liquid-filled cavity by the energetic wave.

5. A sonolaser as claimed in claim 1 wherein the energetic wave is selected from the group consisting of: electromagnetic or electrostatic waves.

6. A sonolaser as claimed in claim 5 wherein the energetic wave is an acoustic wave.

7. A sonolaser as claimed in claim 1, wherein the emitter is selected from the group consisting of: acoustic, electrostatic and electromagnetic.

8. A sonolaser as claimed in claim 1 wherein the gas is selected from the group consisting of: noble gases, alkali metals, transition metals and metastable compounds.

9. A sonolaser as claimed in claim 1 wherein the gas is selected from the group consisting of: He, Ne, Ar, Xe, Kr, N, N₂, CO, CH₂, C₆H₆, CN, Na, Fe, and Cr.

10. A sonolaser as claimed in claim 1 wherein the gas is a mixture of at least two noble gases.

11. A sonolaser as claimed in claim 10 wherein one of the at least two noble gases comprises about 1% or less of the mixture by mass.

12. A sonolaser as claimed in claim 1, wherein the cavity is spherical.

13. A sonolaser as claimed in claim 12, wherein the cavity is made of either glass or silica.

14. A sonolaser as claimed in claim 1, wherein the cavity is a micromachined microcavity.

15. A sonolaser as claimed in claim 14, wherein the cavity is made from a material selected from the group consisting of: silicon, silicon nitrite, gallium arsenide, and silicon carbide.

16. A sonolaser as claimed in claim 14, wherein the cavity is made by optical lithography, e-beam lithography and surface micromachining.

17. A sonolaser as claimed in claim 1, wherein the emitter is selected from the group consisting of: acoustic, electrostatic and electromagnetic.

18. A sonolaser as claimed in claim 1 , wherein the cavity further comprises a gas inlet.

19. A sonolaser as claimed in claim 1, wherein the cavity further comprises an outlet transparent to visible light emission.

20. A sonolaser as claimed in claim 1, wherein the sonolaser further comprises a bandpass filter arranged such that the coherent visible light emission passes therethrough.

21. A sonolaser as claimed in claim 1, wherein the cavity further comprises a deformable membrane arranged between the gas and the emitter.

22. A sonolaser as claimed in claim 1, wherein the quantity of gas is comprises at least one bubble of gas.

23. A sonolaser as claimed in claim 22, further comprising a bubble emitter for creating the at least one gas bubble.

24. A sonolaser as claimed in claim 23, wherein the bubble emitter is selected from the group consisting of: a gas injector; a heating element, a laser.

25. A sonolaser as claimed in claim 23, wherein the bubble emitter is the energy emitter.

26. A sonolaser as claimed in claim 1, wherein the quantity of gas defines a volume and wherein the volume is compressed by at least a factor of 10.

27. A sonolaser as claimed in claim 1, wherein the quantity of gas has a compressed temperature of between about 1,000 and 20,000 K.

28. A sonolaser as claimed in claim 1, having an emission cycle rate between about 2 kHz and 2 MHz.

29. A sonolaser as claimed in claim 1, wherein the quantity of gas has a maximum radius between about 10 and 50 microns and a compressed radius of between about 0.1 and 5.0 microns.

30. A sonolaser as claimed in claim 1, wherein the superradiant coherent visible light emission is a collective molecular emission.

31. A sonolaser as claimed in claim 1, further comprising a temperature controller for controlling the temperature of the cavity.

32. A sonolaser as claimed in claim 1, further comprising a pressure controller for controlling the ambient pressure within the cavity.

33. A sonolaser as claimed in claim 1, further comprising an emission controller for controlling the spatial orientation of the emission.

34. A sonolaser as claimed in claim 1, further comprising a magnetic field emitter in radiant communication with the inner volume.

35. A sonolaser as claimed in claim 1, wherein where the cooperative time of the emission is less than the inhomogeneous broadening time of the emission.

36. A method of producing coherent superradiant sonoluminescence comprising:
providing a sample of gas in a cavity; and
compressing the gas under the action of a resonating pressure applied to the cavity by an energy source such that the gas emits a superradiant coherent pulse of visible light.

37. A method as claimed in claim 36 further comprising filling the cavity with a liquid and locating the gas in the liquid under the action of the energy source.

38. A method as claimed in claim 37 including forming the gas by subjecting a selected area of the liquid in the cavity to a heat sufficient to form a gas from the liquid.

39. A method as claimed in claim 37 including forming the gas by boiling the liquid in an area within the cavity.

40. A method as claimed in claim 37 including forming the gas by electrolyzing the liquid.

41. A method as claimed in claim 37 including at least partially degassing the liquid.

42. A method as claimed in claim 36 including adding a second heavier gas to the cavity to provide a mixture of gases.

43. A method as claimed in claim 42 wherein the second heavier gas is provided in a concentration of about 5% or less of the total mass of gas.

44. A method as claimed in claim 36 wherein the gas is selected from the group consisting of: noble gases, alkali metals, transition metals and metastable compounds.

45. A method as claimed in claim 36 wherein the liquid is selected from thegroup consisting of: water, oil or a liquified gas.

46. A method as claimed in claim 36 wherein the energy source is either an electrostatic or electromagnetic source.

47. A method as claimed in claim 36 wherein the gas defines a volume and wherein the volume of the gas is compressed by at least a factor of 10.

48. A method as claimed in claim 36 wherein the gas has a compressed temperature of between about 1,000 and 20,000 K.

49. A method as claimed in claim 36 wherein emission cycles at a rate between about 2 kHz and 2 MHz.

50. A method as claimed in claim 36 wherein the gas defines a maximum radius between about 10 and 50 microns and a compressed radius of between about 0.1 and 5.0 microns.

51. A method as claimed in claim 36 wherein the coherent visible light emission is a collective molecular emission.

52. A method as claimed in claim 36 wherein the resonating pressure is an acoustic wave.

53. A method as claimed in claim 36 wherein the resonating pressure causes the gas to compress in size to less than about 5 microns.

54. A method as claimed in claim 36 wherein the resonating pressure causes the gas to collapse in size to less than about 2 microns.

55. A sonolaser comprising:
a liquid filled spherical cavity defining an inner volume;
at least one energy emitter for emitting an energetic wave, in radiant communication with the inner volume;
at least one bubble of gas contained within the inner volume, wherein the at least one bubble of gas is suspended in the center of the inner volume by the energetic wave; and
wherein the energetic wave is capable of compressing the at least one bubble of gas such that the at least one bubble of gas emits a substantially superradiant coherent visible light emission.

56. A sonolaser comprising:
a microcavity defining an inner volume and having a gas inlet and a portion transparent to visible light;
a quantity of gas contained with the inner volume;
at least one energy emitter for emitting an energetic wave, in radiant communication with the inner volume, wherein the energetic wave is capable of compressing the quantity of gas such that the quantity of gas emits a substantially superradiant coherent visible light emission.

57. An optical display device comprising:
at least one sonolaser as claimed in claim 1 in optical communication with a phosphorescent screen.

58. An optical switching device comprising:
at least one sonolaser as claimed in claim 1 in optical communication with light sensitive semiconductor device capable of converting light energy into a conductance change.

59. A electron current source comprising:
at least one sonolaser as claimed in claim 1 in optical communication with a light sensitive semiconductor device capable of converting light energy electrical current.

60. A sensor comprising:
a sonolaser as claimed in claim 1 in optical communication with a sample cell and a light sensitive detector.
